(19) United States
(12) Patent Application Publication
(10) Pub. No.: US 2009/0316415 A1
(43) Pub. Date: Dec. 24, 2009

(54) LAMP UNIT

(75) Inventor: Noriko Sato, Shizuoka (JP)

Correspondence Address: OSHA LIANG L.L.P., TWO HOUSTON CENTER, 909 FANNIN, SUITE 3500, HOUSTON, TX, 77010, US

(73) Assignee: KOITO MANUFACTURING CO., LTD., Tokyo (JP)

(21) Appl. No.: 12/483,832

(22) Filed: Jun. 12, 2009

(30) Foreign Application Priority Data
Jun. 23, 2008 (JP) 2008-163218

(51) Int. Cl. F21V 7/00; F23Q 23/08

(52) U.S. Cl. 362/296.01; 445/3

(57) ABSTRACT

A lamp unit includes a linear light source that extends at an angle with respect to an optical axis; and a reflector that reflects light radiated from the linear light source. The reflector has a predetermined section that reflects light radiated from the linear light source such that images of the linear light source projected on a predetermined virtual panel extend in a predetermined direction. The reflector is configured so as to forms a high-intensity region that linearly extends in the predetermined direction and whose intensity of which is higher than a surrounding area. The high-intensity region is formed by superimposing light reflected by the predetermined section and a surrounding section thereof on the virtual plane.

### BACKGROUND OF INVENTION

1. Field of the Invention

The present invention relates to a lamp unit. More specifically, the present invention relates to a lamp unit that includes a reflector that reflects light radiated from a light source.

2. Related Art

Vehicular headlamps are generally designed capable of forming both a low-beam distribution pattern and a high-beam distribution pattern. However, it is difficult to fully adapt to the various conditions in which vehicles travel using these light distribution patterns alone. One example of proposed countermeasures is a vehicle lighting fixture that forms a light distribution pattern for lane marker illumination, which brightly illuminates lane markers in both the travel lane of a host vehicle and the travel lane of an oncoming vehicle (see Patent Document 1). As another example, a headlight system for a vehicle has been proposed that includes an auxiliary lamp unit that radiates a beam using an auxiliary light distribution pattern that augments the brightness of a side end portion of a headlamp distribution pattern (see Patent Document 2).

[Patent Document 1] U.S. Pat. No. 6,543,922

[Patent Document 2] U.S. Pat. No. 6,722,775.

### SUMMARY OF INVENTION

A water film forms on the road surface during rainy weather. As a consequence, light radiated by a low-beam lamp unit is more likely to be completely reflected forward without any diffuse reflection, and may result in less forward visibility than during times of fair weather. As the result of dedicated research and development, the inventor found that radiating a strong light along the road shoulder on the side of the host vehicle lane, the road shoulder on the side of the oncoming vehicle lane, and the like, improved visibility in these areas, which helped make it easier to drive under the circumstances of reduced forward visibility due to rainy weather. In order to suitably illuminate the respective road shoulders on the sides of the host vehicle lane and the oncoming vehicle lane, a light distribution pattern that includes a linearly extending high-intensity region must be formed.

In view of the above, one or more embodiments of the present invention provide a lamp unit capable of suitably forming a linearly extending high-intensity region using reflected light from a reflector.

A lamp unit according to one or more embodiments of the present invention includes a linear light source that extends at an angle with respect to an optical axis, and a reflector that reflects light radiated from the linear light source. The reflector has a predetermined section that reflects light radiated from the linear light source such that images of the linear light source projected on a predetermined virtual panel extend in a predetermined direction, and forms a high-intensity region that linearly extends in the predetermined direction and whose intensity is higher than a surrounding area by superimposing light reflected by the predetermined section and a surrounding section thereof on the virtual plane.

When the linear light source is arranged so as to extend at an angle with respect to the optical axis, images that are reflected by a location along a periphery of the linear light source and projected on the virtual plane extend so as to follow the peripheral direction of that location. According to this aspect, by thus overlapping the images of the linear light source that extend in a predetermined direction or similar direction, a high-intensity region that linearly extends in a predetermined direction can be more easily generated in comparison to when the linear light source is arranged parallel to the optical axis. Therefore, a lamp unit that radiates light in a suitable manner toward a linearly extending location such as a road shoulder, for example, can be provided with a simple configuration. It should be noted that in place of the high-intensity region, the reflector may form a highly luminous region that linearly extends in a predetermined direction and whose luminosity is higher than a surrounding area.

The predetermined section of the reflector may be positioned on a side that is the same in the right-left direction with respect to the optical axis and a position on the virtual plane where the high-intensity region is to be formed.

When the predetermined section is positioned on the same side in the right-left direction with respect to the optical axis and a position on the virtual plane where the high-intensity region is to be formed, light reflected at the predetermined section of the reflector must advance toward the opposite side in the right-left direction between the optical axis and the predetermined section. Designing a reflector that reflects light in this manner is generally difficult. According to this aspect, an optical system that includes the reflector can be easily designed, because light reflected at the predetermined section of the reflector advances toward a side that is the same in the right-left direction when using the optical axis and the predetermined section as a reference.

The lamp unit may further include a light source image forming member that forms a light source image that includes the high-intensity region on the virtual plane using light reflected by the reflector, and a projection lens that projects the formed light source image on a predetermined virtual screen different from the virtual plane. According to this aspect, by using the projection lens to project the high-intensity region that is formed on the virtual plane, a linearly extending location can be suitably illuminated.

The linear light source may be arranged above the optical axis, and the reflector provided such that the predetermined section is positioned below the linear light source.

The lamp unit capable of forming a linear high-intensity region in this manner can be considered applicable to radiating light toward a road shoulder on the side of the host vehicle lane that linearly extends in the bottom-left direction from a vanishing point, and toward a road shoulder on the side of the oncoming vehicle lane that linearly extends in the bottom-right direction from the vanishing point. For example, to form a light distribution pattern having a high-intensity region that linearly extends in the bottom-left direction from the optical axis through the projection lens in order to strongly radiate light toward the road shoulder on the host vehicle lane side, light source images having the high-intensity region that linearly extends in the top-right direction from the optical axis must be formed in the vicinity of a rearward focal plane of the projection lens.

As described above, when the linear light source is arranged so as to extend at an angle with respect to the optical axis, images that are reflected by a location along a periphery of the linear light source and projected on the virtual plane extend so as to follow the peripheral direction of that location. Accordingly, the images of the linear light source reflected in sections that are farther bottom-right and top-left than the linear light source extend toward the top-right direction. However, for example, to form the high-intensity region using light that is reflected by a predetermined section above the linear light source, a section that is farther top-left than the linear light source is utilized. Therefore, when forming the light source images having the high-intensity region that linearly extends in the top-right direction from the optical axis, the light source images are formed on a side opposite in the right-left direction between the optical axis and a reflective surface of the reflector, which causes difficulty in terms of optical system design. Note that, in the case of forming a light distribution pattern having a high-intensity region that linearly extends in the bottom-right direction from the optical axis through the projection lens as well, when the high-intensity region is formed using light that is reflected at the predetermined section above the linear light source, it is difficult to design an optical system for forming the light source images having the high-intensity region that linearly extends in the top-left direction from the optical axis.

According to this aspect, a high-intensity region that linearly extends in the top-right direction from the optical axis and a high-intensity region that linearly extends in the top-left direction from the optical axis can be suitably formed with a simple optical system design. Therefore, a lamp unit capable of suitably radiating light toward a road shoulder on the side of the host vehicle lane, a road shoulder on the side of the oncoming vehicle lane, and the like can be provided.

The reflector may form a light distribution pattern that includes part of the high-intensity region on a virtual screen that is the virtual plane by reflecting light radiated from the linear light source toward the virtual screen. According to this aspect, a light distribution pattern that includes a linearly extending high-intensity region can be formed with a parabola optical system that forms the light distribution pattern using light that is reflected by the reflector and does not pass through the projection lens.

In a lamp unit according to one or more embodiments of the present invention, a linearly extending high-intensity region can be suitably formed utilizing reflected light from a reflector.

Other aspects and advantages of the invention will be apparent from the following description, the drawings and the claims.

### BRIEF DESCRIPTION OF DRAWINGS

FIG. 1 is a cross-sectional view of a lamp unit according to an embodiment as seen from the right side.

FIG. 2 is a cross-sectional view taken along a line P-P in FIG. 1.

FIG. 3 is a view showing a high-intensity region that is to be formed on a virtual vertical screen by the lamp unit according to the present embodiment.

FIG. 4 is a view of a shade as seen from a viewpoint Q in FIG. 1.

FIG. 5 is a view showing a correspondence relationship between the position of a reflective surface of a reflector and images of a filament that are formed on the shade by reflected light at this position.

FIG. 6 is a view showing a state in which light reflected by a first section and a surrounding section thereof overlaps at a first opening portion.

FIG. 7 is a view showing an intensity distribution of a light source image formed on the shade.

### DETAILED DESCRIPTION

Embodiments of the present invention will be described in detail below with reference to the drawings.

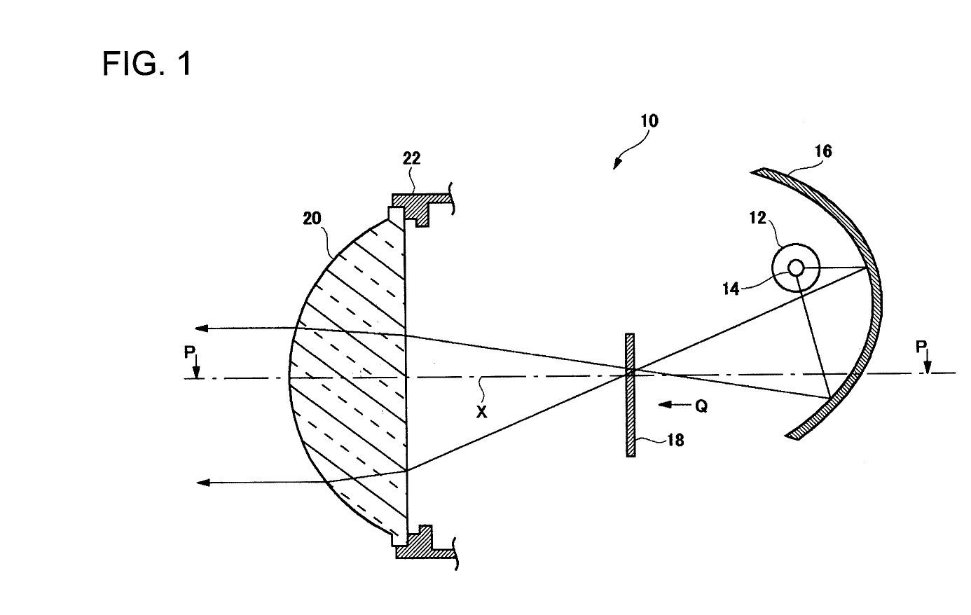

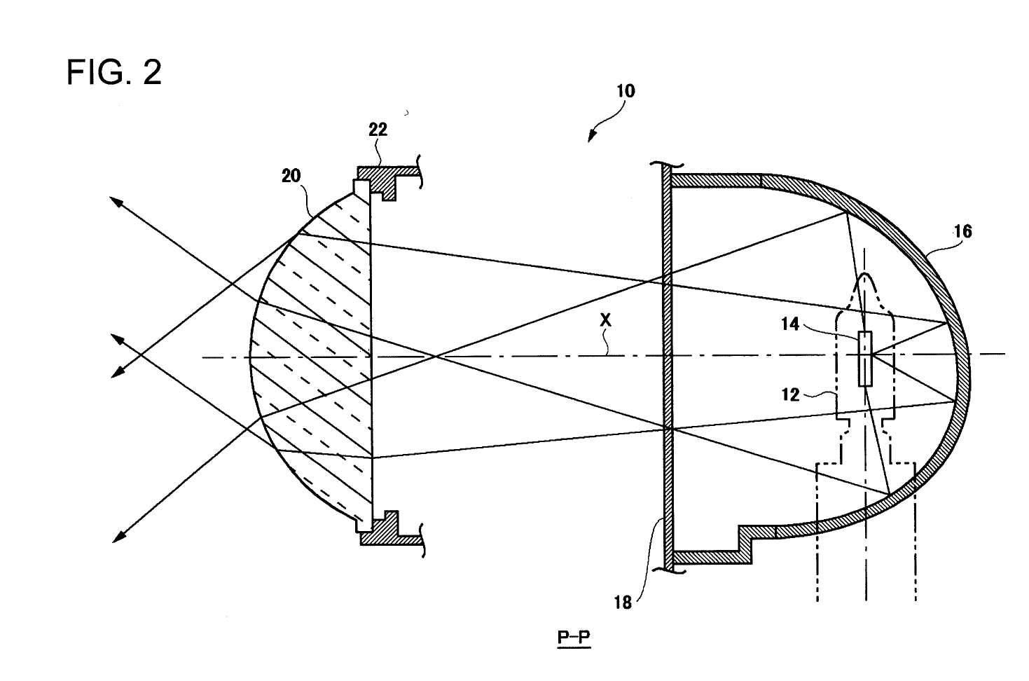

FIG. 1 is a cross-sectional view of a lamp unit 10 according to an embodiment as seen from the right side. FIG. 1 shows a cross-sectional view along a vertical plane that includes an optical axis X of the lamp unit 10. FIG. 2 is a cross-sectional view taken along a line P-P in FIG. 1. A detailed description of a configuration of the lamp unit 10 will be given below in relation to both FIGS. 1 and 2.

The lamp unit 10 includes a light source bulb 12, a reflector 16, a shade 18, a projection lens 20, and a holder 22. The light source bulb 12 is configured by an incandescent lamp that includes a filament 14, such as a halogen lamp or the like. The filament 14 is formed so as to extend in a linear fashion. The light source bulb 12 emits light as a result of light radiated from the filament 14. Therefore, the filament 14 functions as a linear light source.

It should be noted that, for the light source bulb 12, a discharge lamp formed from an HID lamp (also known as a discharge lamp) such as a metal halide bulb may be adopted. A light source element may also be used in place of the light source bulb 12. The light source element may be configured by a light-emitting chip that is formed from a semiconductor light-emitting element and by a thin film that is provided so as to cover the light-emitting chip. Note that, in the case of a discharge lamp adopted as the light source bulb 12 and in the case of a light source element adopted in place of the light source bulb 12, their light-emitting parts are formed so as to extend in a linear fashion.

In the light source bulb 12, the filament 14 is arranged so as to extend perpendicular to the optical axis X and in the horizontal direction. It should be noted that in the light source bulb 12, the filament 14 need not extend perpendicular to the optical axis X, and the filament 14 may be arranged so as to extend at an angle with respect to the optical axis X. In addition, the filament 14 may not be arranged in the light source bulb 12 so as to extend in the horizontal direction. For example, the filament 14 may be arranged so as to extend in the vertical direction, or the filament 14 may be arranged so as to extend inclined at an angle from the horizontal direction.

The reflector 16 is disposed behind the light source bulb 12. An inner surface of the reflector 16 has a reflective surface with a curved configuration that surrounds the light source bulb 12. The projection lens 20 is disposed in front of the reflector 16. The projection lens 20 is formed from a planoconvex aspherical lens, wherein a front-side surface is a convex surface and a rear-side surface is a plane surface. A light source image that is formed on a rearward focal plane is projected as an inverted image ahead of the lamp unit 10. The projection lens 20 is supported by the holder 22. The shade 18 is disposed in front of the reflector 16 and in the vicinity of the rearward focal plane of the projection lens 20. The shade 18 is shaped as a plate, and a surface of the shade 18 is arranged so as to be perpendicular to the optical axis X.

Light radiated by the filament 14 of the light source bulb 12 is reflected toward the shade 18 by the reflective surface of the reflector 16. The shade 18 uses reflected light from the reflector 16 to form a light source image. Therefore, the shade 18 functions as light source image forming means. The projection lens 20 projects the light source image formed by the shade 18 as an inverted image onto a virtual vertical screen ahead of the lamp unit 10. The present embodiment will be explained using a projected image that is formed on a virtual vertical screen disposed at a position 25 meters ahead of the vehicle as a reference. Also, note that the virtual plane on which the projection image is formed is obviously not limited to the vertical plane above, and for example, a horizontal plane that assumes a road surface is also acceptable.

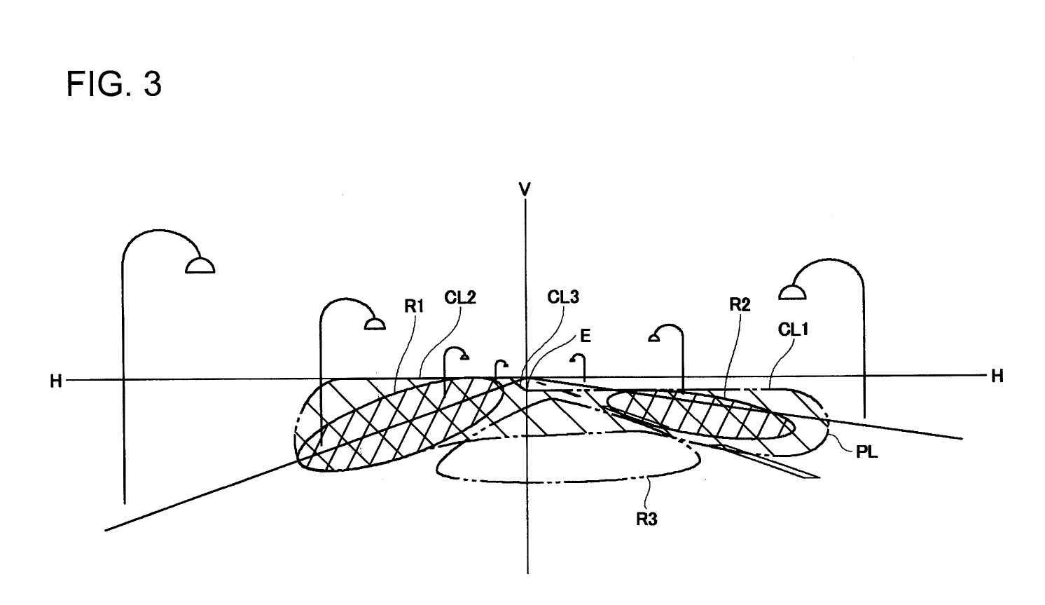

FIG. 3 is a view showing a high-intensity region that is formed on the virtual vertical screen by the lamp unit 10 according to the present embodiment. In a vehicle mounted with the lamp unit 10, low-beam lamp units (not shown) that form a low-beam distribution pattern PL are provided on front-right and front-left portions of the vehicle.

The low-beam distribution pattern PL is a low-beam distribution pattern for left light distribution, and a top end edge thereof has first, second, and third cut-off lines CL1, CL2, CL3. The first, second, and third cut-off lines CL1, CL2, CL3 extend in the horizontal direction and are provided with a left-right direction step at a boundary defined by a line V-V that passes vertically through a point H-V, which is a vanishing point in the forward direction of the lamp. The first cut-off line CL1 extends in the horizontal direction below a line H-H and rightward of the line V-V. Therefore, the first cut-off line CL1 is utilized as a cut-off line for the oncoming vehicle lane. The third cut-off line CL3 extends diagonally at an inclination angle of 15 degrees in the top-left direction from a left end portion of the first cut-off line CL1. The second cut-off line CL2 extends along the line H-H on the left side from the intersection of the third cut-off line CL3 and the line H-H. Therefore, the second cut-off line CL2 is utilized as a cut-off line for the host vehicle lane side. In the low-beam distribution pattern PL, an elbow point E at the intersection of the first cut-off line CL1 and the line V-V is positioned below the point H-V, and a hot zone, i.e., a high-intensity region, is formed so as to somewhat surround the elbow point E from the left.

Due to a film formed by water on the road surface during rainy weather, even if light is radiated forward by the low-beam lamp unit, light that reaches the road surface is more likely to be completely reflected forward without any diffusion reflection. If light radiated toward the road surface is completely reflected in this manner, less reflected light from the road surface is reflected toward the driver of the vehicle, which may result in reduced visibility ahead of the vehicle.

When the vehicle is traveling straight, the driver of the vehicle can see that the road shoulder on the host vehicle lane side linearly extends in the bottom-left direction from the point H-V, which is the intersection of the line H-H and the line V-V, i.e., the vanishing point ahead of the vehicle. The driver can also see that the road shoulder on the oncoming vehicle lane side linearly extends in the bottom-right direction from the point H-V. As the result of dedicated research and development, the inventor found that radiating a strong light along the road shoulder on the side of the host vehicle lane, the road shoulder on the side of the oncoming vehicle lane, and the like, improved visibility in these areas, which helped make it easier to drive under the circumstances of reduced forward visibility due to rainy weather. However, it is difficult to brightly illuminate the road shoulder on the host vehicle lane side and the road shoulder on the oncoming vehicle lane side using the low-beam lamp unit.

Therefore, the lamp unit 10 is provided in order to supplement the radiation of light by the low-beam lamp unit especially in times of rainy weather. The lamp unit 10 is respectively provided on the front-right and front-left portions of the vehicle. It should be noted that only one lamp unit 10 may be disposed at the front portion of the vehicle, or a plurality of lamp units 10 may be respectively arranged on the front-right and front-left portions of the vehicle.

The lamp unit 10 forms a light distribution pattern that includes a first high-intensity region R1, which linearly extends in the bottom-left direction from the point H-V so as to follow the road shoulder on the side of the host vehicle lane. The first high-intensity region R1 is formed below the second cut-off line CL2. By forming the first high-intensity region R1 in this manner, the visibility of road structures and the road shoulder on the host vehicle lane side can be increased.

The lamp unit 10 also forms a light distribution pattern that includes a second high-intensity region R2, which linearly extends in the bottom-right direction from the point H-V so as to follow the road shoulder on the side of the oncoming vehicle lane. The second high-intensity region R2 is formed such that an upper end thereof is positioned below the first cut-off line CL1. By forming the second high-intensity region R2 in this manner, the visibility of pedestrians walking along the road shoulder on the oncoming vehicle lane side can be increased.

Further, note that the lamp unit 10 is provided so as to avoid the radiation of light toward a radiation avoidance region R3 that is positioned on the oncoming vehicle lane and on the host vehicle lane between the first high-intensity region R1 and the second high-intensity region R2. If light is radiated on the road surface in front of the vehicle in this manner during rainy weather, light that reaches the road surface is likely to be completely reflected forward without any diffusion reflection and dazzle the drivers of vehicles ahead, including oncoming vehicles and preceding vehicles. The lamp unit 10 avoids radiating light toward such areas, which helps to suppress the dazzling of drivers of vehicles ahead.

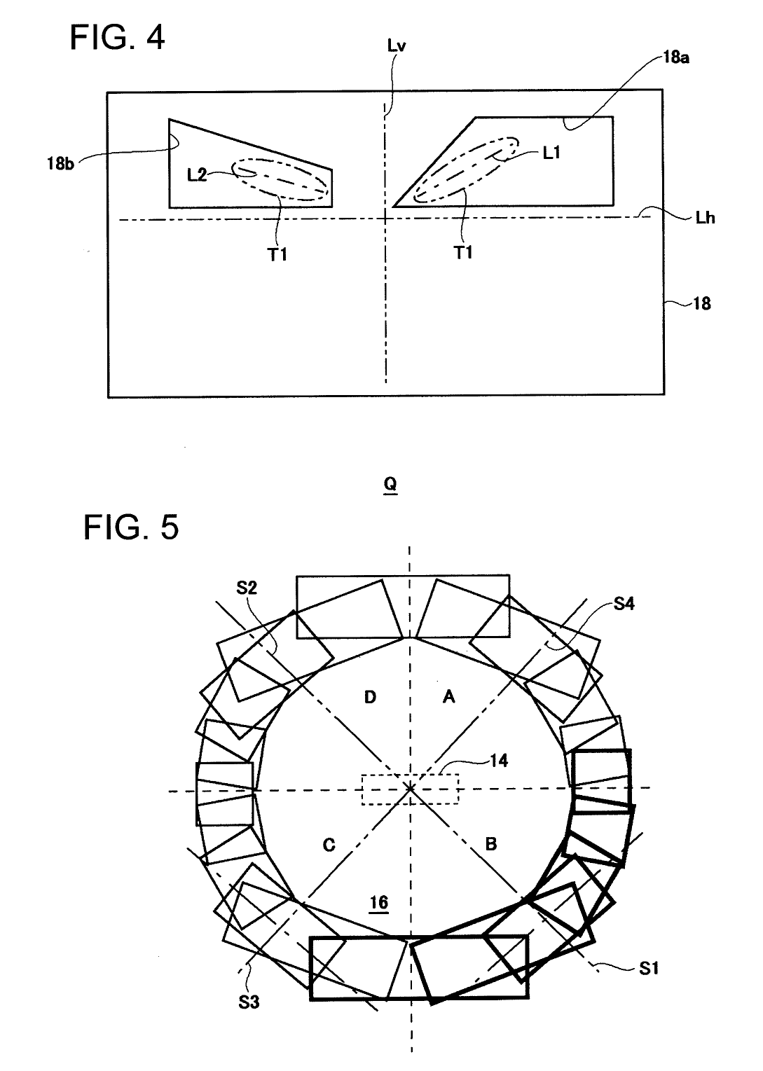

FIG. 4 is a view of the shade 18 as seen from a viewpoint Q in FIG. 1. The shade 18 is formed into a rectangular shape that is long in the horizontal direction. A virtual line projected on the line H-H by the projection lens 20 is indicated as a virtual H-H line Lh. Also, a virtual line projected on the line V-V by the projection lens 20 is indicated as a virtual V-V line Lv.

The shade 18 is provided with a first opening portion 18a and a second opening portion 18b. The first opening portion 18a forms a light source image for forming a light distribution pattern that includes the first high-intensity region R1. The projection lens 20 projects the inverted image of the light source image formed by the shade 18 onto a virtual vertical screen. Accordingly, the first opening portion 18a is provided above the virtual H-H line Lh and rightward of the virtual V-V line Lv. The first opening portion 18a is formed such that upper and lower sides thereof are parallel to the virtual H-H line Lh, and the left side thereof linearly extends in the top-right direction from the intersection of the virtual H-H line Lh and the virtual V-V line Lv.

The second opening portion 18b forms a light source image for forming a light distribution pattern that includes the second high-intensity region R2. Accordingly, the second opening portion 18b is provided above the virtual H-H line Lh and leftward of the virtual V-V line Lv. The second opening portion 18b is formed such that the left and right sides thereof are parallel to the virtual V-V line Lv, and the upper side thereof extends in the top-left direction.

Inside the first opening portion 18a, a first line L1 that is a light source image part of a section that corresponds to the road shoulder on the host vehicle lane side linearly extends in the top-right direction from the intersection of the virtual H-H line Lh and the virtual V-V line Lv. To form the first high-intensity region R1 on the virtual vertical screen, as illustrated in FIG. 4, a first high-intensity region T1 that centrally includes the first line L1 and extends in the same direction as the first line L1 must be formed in the first opening portion 18a. Inside the second opening portion 18b, a second line L2 that is a light source image part of a section that corresponds to the road shoulder on the oncoming vehicle lane side linearly extends in the top-left direction from the intersection of the virtual H-H line Lh and the virtual V-V line Lv. To form the second high-intensity region R2 on the virtual vertical screen, as illustrated in FIG. 4, a second high-intensity region T2 that centrally includes the second line L2 and extends in the same direction as the second line L2 must be formed in the second opening portion 18b.

FIG. 5 is a view showing a correspondence relationship between the position of the reflective surface of the reflector 16 and images of the filament 14 that are formed on the shade 18 by reflected light at this position. FIG. 5 indicates the correspondence relationship as seen from behind of multiple locations among the reflective surface of the reflector 16, which are positioned on a circle that surrounds the filament 14. It should be noted that the images of the filament 14 in FIG. 5 are schematically shown for easier comprehension, and the actual images of the filament 14 are smaller. Four regions are defined by vertical and horizontal lines that pass through the center of the filament 14 among the reflective surface of the reflector 16, wherein a top-right region is designated as a region A, a bottom-right region as a region B, a bottom-left region as a region C, and a top-left region as a region D.

By arranging the filament 14, i.e., the linear light source, so as to extend perpendicular to the optical axis, corresponding images of the filament 14, namely, the linear light source, extend in the peripheral direction. Arranging the filament 14 so as to extend in a horizontal manner makes an image of the filament 14 that corresponds to a location below the filament 14 and an image of the filament 14 that corresponds to a location above the filament 14 the most extended. The image of the filament 14 becomes shorter nearer locations to the right and left of the filament 14 and farther from locations above and below the filament 14.

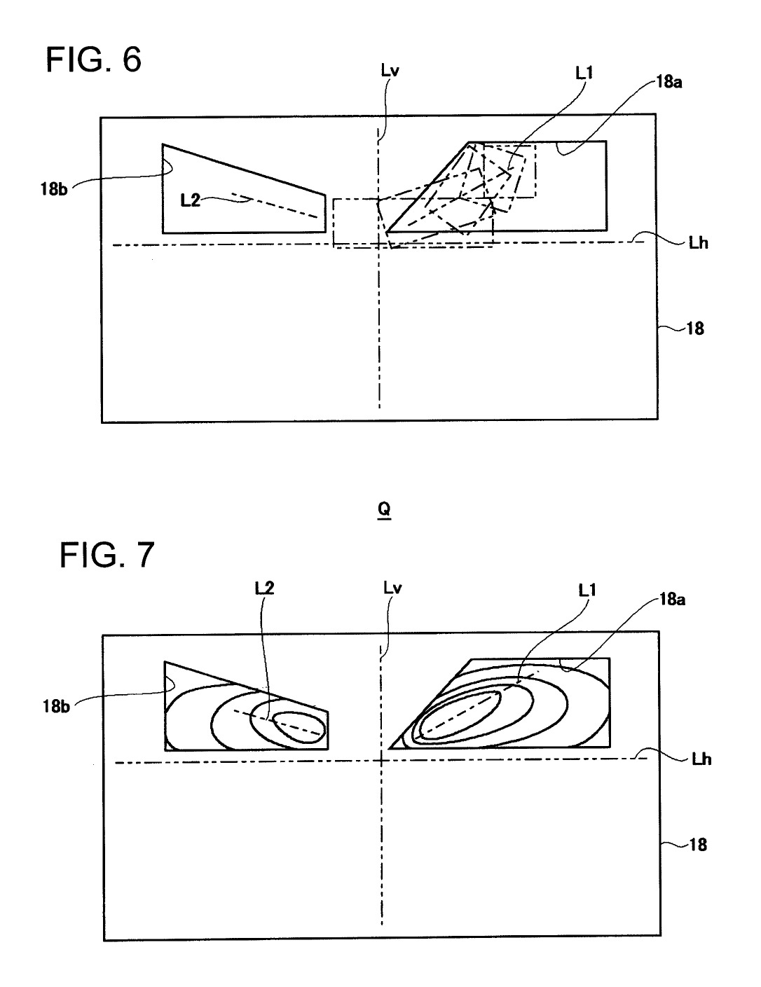

As FIG. 6 illustrates, the images of the filament 14 that are projected in the first opening portion 18a by reflecting a predetermined section among the reflective surface of the reflector 16 extend parallel to the first line L1. In the present embodiment, a section below and a section above the filament 14, in this predetermined section, are designated as a first section S1 and a second section S2, respectively. The first section S1 linearly extends on the reflective surface of the reflector 16 in the bottom-right direction from a part that is positioned behind the filament 14. The second section S2 linearly extends on the reflective surface of the reflector 16 in the top-left direction from a part that is positioned behind the filament 14.

The reflector 16 is provided such that light reflected by the first section S1 and a surrounding section thereof, namely, the region B, overlaps at the first opening portion 18a, whereby the first high-intensity region T1 that extends parallel to the first line L1 is formed inside the first opening portion 18a so as to centrally include the first line L1. Note that the reflector 16 may form inside the first opening portion 18a a high-intensity region that extends parallel to the first line L1 and whose intensity is higher than a surrounding area.

As FIG. 5 illustrates, the images of the filament 14 that are projected in the second opening portion 18b by reflecting another predetermined section among the reflective surface of the reflector 16 extend parallel to the second line L2. In the present embodiment, a section below and a section above the filament 14, in this another predetermined section, are designated as a third section S3 and a fourth section S4, respectively. The third section S3 linearly extends on the reflective surface of the reflector 16 in the bottom-left direction from a part that is positioned behind the filament 14. The fourth section S4 linearly extends on the reflective surface of the reflector 16 in the top-right direction from a part that is positioned behind the filament 14.

The reflector 16 is provided such that light reflected by the third section S3 and a surrounding section thereof, namely, the region C, overlaps at the second opening portion 18b, whereby the second high-intensity region T2 that extends parallel to the second line L2 is formed. However, the reflector 16 may form inside the second opening portion 18b a high-intensity region that extends parallel to the second line L2.

FIG. 6 is a view showing a state in which light reflected by the first section S1 and a surrounding section thereof overlaps at the first opening portion 18a. It should be noted that the images of the filament 14 in FIG. 6 are schematically shown for easier comprehension, and the actual images are smaller.

The reflector 16 superimposes light reflected by the first section S1 and a surrounding section thereof such that the centers of the reflected images of the filament 14 are positioned on the first line L1 inside the first opening portion 18a. The reflector 16 also reflects light radiated from the filament 14 such that the centers of the reflected images of the filament 14 gradually advance in the top-right direction along the first line L1 from a bottom-left end portion of the first line L1, in accordance with a gradual advance from the bottom-left section of the region B in the top-right direction.

Similarly, the reflector 16 superimposes light reflected by the third section S3 and a surrounding section thereof such that the centers of the reflected images of the filament 14 are positioned on the second line L2 inside the second opening portion 18b. The reflector 16 also reflects light radiated from the filament 14 such that the centers of the reflected images of the filament 14 gradually advance in the top-left direction along the second line L2 from a bottom-right end portion of the second line L2, in accordance with a gradual advance from the bottom-right section of the region C in the top-left direction.

By arranging the filament 14 so as to extend perpendicular to the optical axis, corresponding images of the filament 14 extend in the peripheral direction as shown in FIG. 5. Utilizing images of the filament 14 that extend in the peripheral direction in this manner enables easy overlapping of part of the images of the filament 14 so that they line up in a linear fashion, and enables easy generation of a linear high-intensity region along the first line L1 or the second line L2.

The reflector 16 is provided such that light reflected by the first section S1 and a surrounding section thereof positioned on the right side forms the first high-intensity region T1 on the right side of the shade 18. Similarly, the reflector 16 is provided such that light reflected by the third section S3 and a surrounding section thereof positioned on the left side forms the second high-intensity region T2 on the left side of the shade 18. Thus, a more simple design can be achieved for the reflector 16 and the projection lens 20 in comparison to that used when light that reflects a predetermined section of the reflector 16 forms a high-intensity region on the shade 18 on a side opposite to the predetermined section in the right-left direction.

Alternatively, the filament 14 is arranged above the optical axis X. The reflector 16 forms the first high-intensity region T1 inside the first opening portion 18a using light reflected by the first section S1 and a surrounding section thereof positioned below the filament 14, namely, the region B. The reflector 16 forms the second high-intensity region T2 inside the second opening portion 18b using light reflected by the third section S3 and a surrounding section thereof positioned below the filament 14.

For example, in addition to the first section S1, the second section S2 also exists as a predetermined section among the reflective surface of the reflector 16 at which the images of the filament 14 projected on the rearward focal plane of the projection lens 20 extend parallel to the first line L1. However, if light reflected by the second section S2 and a surrounding section thereof is utilized to form the first high-intensity region T1 in the first opening portion 18a, then light that is reflected by the left side of the reflector 16 must be made incident to the first opening portion 18a on the opposite side in the right-left direction.

Similarly, in addition to the second line L2, the fourth section S4 also exists as a predetermined section among the reflective surface of the reflector 16 at which the images of the filament 14 projected on the rearward focal plane of the projection lens 20 extend parallel to the second line L2. However, if light reflected by the fourth section S4 and a surrounding section thereof is utilized to form the second high-intensity region T2 in the second opening portion 18b, then light that is reflected by the right side of the reflector 16 must be made incident to the second opening portion 18b on the opposite side in the right-left direction.

Designing the reflector 16 such that reflected light is incident to an opposite side of the shade 18 in the right-left direction is more difficult than designing the reflector 16 such that reflected light is incident to an identical side in the right-left direction. However, by utilizing a part below the filament 14 among the reflective surface of the reflector 16 in the manner described above, a more simple design for the reflector 16 can be achieved, and at the same time, the first high-intensity region T1 and the second high-intensity region T2 can be suitably formed.

FIG. 7 is a view showing an intensity distribution of the light source image formed on the shade 18. In FIG. 7, isolux lines that indicate equivalent intensities are formed in elliptical shapes, wherein a smaller ellipse indicates a higher intensity. As FIG. 7 shows, the first opening portion 18a is formed with a high-intensity region along the first line L1. Also, the second opening portion 18b is formed with a high-intensity region along the second line L2. Accordingly, the light source image formed by the first opening portion 18a and the second opening portion 18b is projected ahead of the lamp unit 10 by the projection lens 20, which enables the suitable radiation of light toward the road shoulder on the side of the host vehicle lane, and the road shoulder on the side of the oncoming vehicle lane.

The present invention is not limited to the embodiments described above, and any configuration that suitably combines the elements of these embodiments is also a valid embodiment of the present invention. In addition, various modifications such as design changes based on the knowledge of persons having ordinary skill in the art may be added to the embodiments, and embodiments with such added modifications are also included in the scope of the present invention.

One such modification example is the lamp unit 10 that does not include the shade 18 or the projection lens 20. In such case, the reflector 16 reflects light radiated from the filament 14 toward the virtual vertical screen without such light passing through the projection lens 20. Thus, the reflector 16 directly projects a light distribution pattern that includes the first high-intensity region R1 and the second high-intensity region R2 on the virtual vertical screen. Even in this type of parabola optical system in which light does not pass through the projection lens 20, a linearly extending high-intensity region can be formed.

It should be noted that the reflector 16 is provided such that light reflected by the second section S2 and a surrounding section thereof positioned on the left side, i.e., the region D, forms the first high-intensity region R1 that is similarly positioned on the left side of the virtual vertical screen. Likewise, the reflector 16 is provided such that light reflected by the fourth section S4 and a surrounding section thereof positioned on the right side, i.e., the region A, forms the second high-intensity region R2 that is similarly positioned on the right side of the virtual vertical screen. Thus, a more simple design can be achieved for the reflector 16 in comparison to that used when light that reflects a predetermined section of the reflector 16 forms a high-intensity region on the virtual vertical screen on a side opposite in the right-left direction. In addition, the reflector 16 may be provided such that light reflected by the region B forms the first high-intensity region R1 and light reflected by the region C forms the second high-intensity region R2.

In order to thus form a high-intensity region on the same side in the right-left direction as the reflective location of the reflector 16, the filament 14 is arranged below the optical axis X. The reflector 16 forms the first high-intensity region R1 on the virtual vertical screen using light reflected by the second section S2 and a surrounding section thereof positioned above the filament 14. The reflector 16 also forms the second high-intensity region R2 on the virtual vertical screen using light reflected by the fourth section S4 and a surrounding section thereof positioned above the filament 14.

While description has been made in connection with exemplary embodiments of the present invention, it will be obvious to those skilled in the art that various changes and modification may be made therein without departing from the present invention. It is aimed, therefore, to cover in the appended claims all such changes and modifications falling within the true spirit and scope of the present invention.

### DESCRIPTION OF THE REFERENCE NUMERALS

10 LAMP UNIT

12 LIGHT SOURCE BULB

14 FILAMENT

16 REFLECTOR

18 SHADE

18a FIRST OPENING PORTION

18b SECOND OPENING PORTION

20 PROJECTION LENS

22 HOLDER

What is claimed is:

1. A lamp unit comprising:
a linear light source that extends at an angle with respect to an optical axis; and
a reflector that reflects light radiated from the linear light source,
wherein the reflector comprises a predetermined section that reflects light radiated from the linear light source such that images of the linear light source projected on a predetermined virtual panel extend in a predetermined direction,
wherein the reflector is configured so as to form a high-intensity region that linearly extends in the predetermined direction and intensity of which is higher than a surrounding area, and
wherein the high-intensity region is formed by superimposing light reflected by the predetermined section and a surrounding section thereof on the virtual plane.

2. The lamp unit according to claim 1,
wherein the predetermined section of the reflector is positioned on a side that is the same in the right-left direction with respect to the optical axis and a position on the virtual plane where the high-intensity region is to be formed.

3. The lamp unit according to claim 1 further comprising:
a light source image forming member that forms a light source image that includes the high-intensity region on the virtual plane using light reflected by the reflector; and
a projection lens that projects the formed light source image on a predetermined virtual screen different from the virtual plane.

4. The lamp unit according to claim 3,
wherein the linear light source is arranged above the optical axis, and
wherein the reflector is provided such that the predetermined section is positioned below the linear light source.

5. The lamp unit according to claim 1,
wherein the reflector forms a light distribution pattern that includes part of the high-intensity region on a virtual screen that is the virtual plane by reflecting light radiated from the linear light source toward the virtual screen.

6. The lamp unit according to claim 2 further comprising:
a light source image forming member that forms a light source image that includes the high-intensity region on the virtual plane using light reflected by the reflector; and
a projection lens that projects the formed light source image on a predetermined virtual screen different from the virtual plane.

7. The lamp unit according to claim 6,
wherein the linear light source is arranged above the optical axis, and
wherein the reflector is provided such that the predetermined section is positioned below the linear light source.

8. The lamp unit according to claim 2,
wherein the reflector forms a light distribution pattern that includes part of the high-intensity region on a virtual screen that is the virtual plane by reflecting light radiated from the linear light source toward the virtual screen.

9. A method of manufacturing a lamp unit comprising:
configuring a linear light source to extend at an angle with respect to an optical axis; and
configuring a reflector to reflect light radiated from the linear light source,
wherein the reflector has a predetermined section that reflects light radiated from the linear light source such that images of the linear light source projected on a predetermined virtual panel extend in a predetermined direction,
wherein the reflector is configured so as to form a high-intensity region that linearly extends in the predetermined direction and intensity of which is higher than a surrounding area, and
wherein the high-intensity region is formed by superimposing light reflected by the predetermined section and a surrounding section thereof on the virtual plane.

10. The method of manufacturing a lamp unit according to claim 9 further comprising:
positioning the predetermined section of the reflector on a side that is the same in the right-left direction with respect to the optical axis and a position on the virtual plane where the high-intensity region is to be formed.

11. The method of manufacturing a lamp unit according to claim 9 further comprising:
configuring a light source image forming member to form a light source image that includes the high-intensity region on the virtual plane using light reflected by the reflector; and
configuring a projection lens to project the formed light source image on a predetermined virtual screen different from the virtual plane.

12. The method of manufacturing a lamp unit according to claim 11 further comprising:
arranging the linear light source above the optical axis, and
providing the reflector such that the predetermined section is positioned below the linear light source.

13. The method of manufacturing a lamp unit according to claim 9,
wherein the reflector forms a light distribution pattern that includes part of the high-intensity region on a virtual screen that is the virtual plane by reflecting light radiated from the linear light source toward the virtual screen.

14. The method of manufacturing a lamp unit according to claim 10 further comprising:
configuring a light source image forming member to form a light source image that includes the high-intensity region on the virtual plane using light reflected by the reflector; and
configuring a projection lens to project the formed light source image on a predetermined virtual screen different from the virtual plane.

15. The method of manufacturing a lamp unit according to claim 14 further comprising:
arranging the linear light source above the optical axis, and
providing the reflector such that the predetermined section is positioned below the linear light source.

16. The lamp unit according to claim 10,
wherein the reflector forms a light distribution pattern that includes part of the high-intensity region on a virtual screen that is the virtual plane by reflecting light radiated from the linear light source toward the virtual screen.
